(19) United States
(12) Patent Application Publication
(10) Pub. No.: US 2010/0158074 A1
(43) Pub. Date: Jun. 24, 2010

(54) MULTIPOINT PROBE ASSEMBLY AND METHOD

(76) Inventors: Rejean Fortier, St-Jean-sur-Richelieu (CA); Mario Gagnon, St-Jean-sur-Richelieu (CA)

Correspondence Address: OGILVY RENAULT LLP (PWC), 1, PLACE VILLE MARIE, SUITE 2500, MONTREAL, QC, H3B 1R1, CA

(21) Appl. No.: 12/339,783

(22) Filed: Dec. 19, 2008

(51) Int. Cl. G01K 1/14; B23P 11/00; G01K 13/00

(52) U.S. Cl. 374/208; 29/428; 374/E13.001; 374/E01.018

(57) ABSTRACT

A probe assembly in a gas path of a gas turbine engine comprises a support casing having a first wall with throughbores. The support casing has a base mounted to a gas turbine engine proximate the gas path. The first wall extends radially into the gas path. The throughbores are provided at positions corresponding to different gas path radii. Wire units each have an end directed to an own throughbore, and an end exiting through an outlet of the casing and connected to a processing unit. Retaining members in the casing constrain movement of the wire units. Probes for each of the throughbores are configured for measuring the temperature/pressure. The probes each have a connector end received in a non-integral relation in the throughbore and connected to an associated wire unit, whereby the probes in the non-integral relation with the support casing measure parameters in the gas path.

### TECHNICAL FIELD

The application relates generally to measurement of operating parameters in gas turbine engines and, more particularly, to an apparatus for the multipoint measurement of temperature or pressure using probe assemblies along a gas path in a gas turbine engine.

### BACKGROUND OF THE ART

Gas turbine engines have multipoint probe assemblies which project into the gas path to simultaneously measure parameters such as temperature at various radial positions in the gas path. The probe assemblies, also referred to as rakes, are typically provided to measure exhaust gas temperature, and sometimes interturbine temperature, among other places in the gas path. In known probe assemblies, the probes are welded or brazed to a rake structure, resulting in heat conduction, thermal growth stress and/or exposure vibration on the probes, which may affect the durability of probes.

### SUMMARY

It is therefore an object to provide a novel probe assembly for gas turbine engines, and a method for installing same.

In one aspect, there is provided a probe assembly for measuring one of temperature and pressure in a gas path of a gas turbine engine, the assembly comprising: a support casing having a first wall with at least two throughbores in the first wall, the support casing having a base mounted to a gas turbine engine proximate the gas path, the first wall extending from the base and configured for extending radially into the gas path, the at least two throughbores provided at positions in the first wall corresponding to different gas path radii; wire units within the support casing, each wire unit having a first end directed to an own one of the throughbores, and a second end exiting through an outlet of the casing and adapted to be connected to a processing unit; retaining members secured to an inside of the casing and constraining movement of the wire units with respect to the support casing; and probes for each of the throughbores configured for measuring at least one of temperature and pressure, the probes having a connector end received in a non-integral relation in the throughbore and connected to an associated one of the wire units; whereby the probes in the non-integral relation with the support casing are actuated to measure parameters in the gas path of the gas turbine engine

In a second aspect, there is provided a method for installing probes in a gas path of a gas turbine engine, comprising: providing a support casing having a first wall with at least two throughbores in a gas turbine engine, the first wall extending radially into the gas path; positioning wire units within the support casing; threading a first end of one said wire unit in each said throughbore and a second end of each said wire unit through an outlet of the support casing to a processing unit; inserting a probe into each said throughbore from an exterior of the support casing to connect the probe to the first end of the wire unit; strapping the wire units to an interior of the support casing to constrain movement of the wire units; and closing the support casing for measuring with the probes parameters in the gas path

### DESCRIPTION OF THE DRAWINGS

Reference is now made to the accompanying figures, in which:

FIG. 1 is a perspective view of a multipoint probe assembly in accordance with an embodiment of the present disclosure;

FIG. 2 is a perspective view of the multipoint probe assembly of FIG. 1, with a cover removed;

FIG. 3 is a sectional view of the multipoint probe assembly of FIG. 1 installed in a gas turbine engine; and

FIG. 4 is a perspective view of another multipoint probe assembly in accordance with an embodiment of the present disclosure.

### DETAILED DESCRIPTION

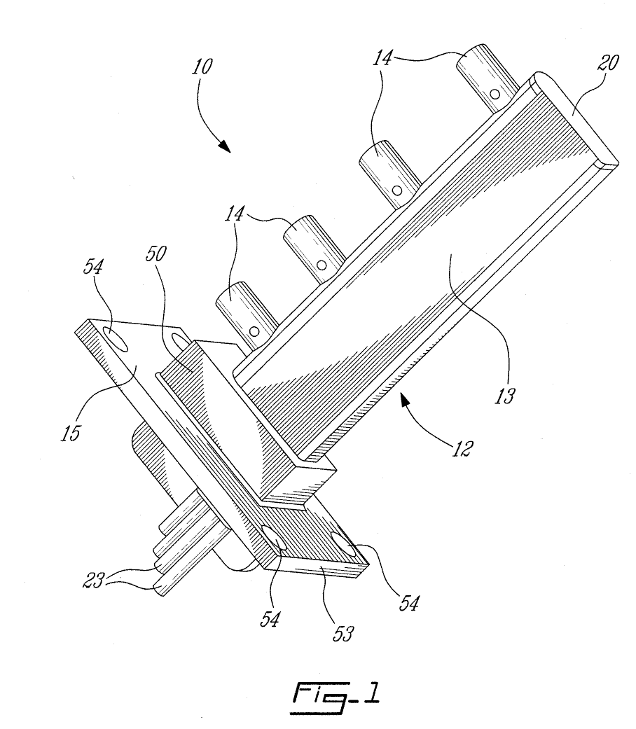

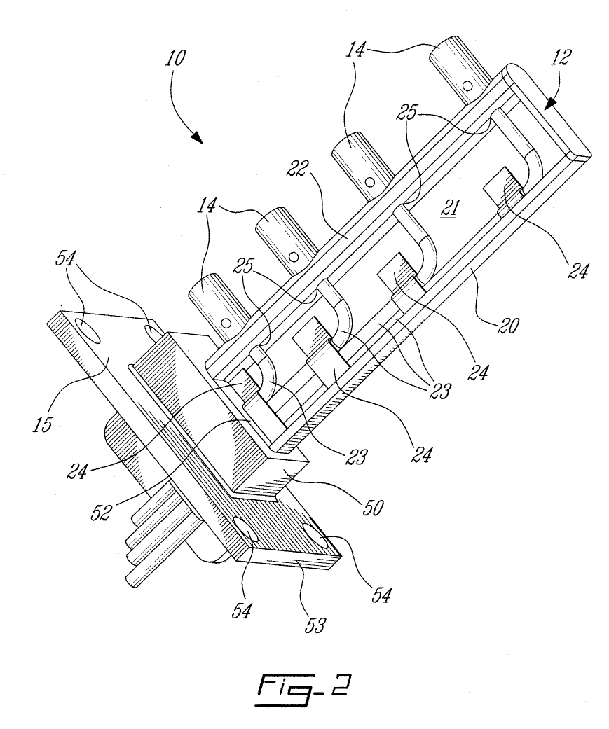

Referring concurrently to FIGS. 1 and 2, a multipoint probe assembly in accordance with an embodiment is generally shown at 10. The probe assembly 10 is used with turbine engines, and has a support 12, a cover 13, probes 14 and a holder 15.

The support 12 supports the probes 14 in a desired arrangement. In FIGS. 1 to 4, the probes 14 are in a rake arrangement, with the probes being in linear alignment. For instance, a rake arrangement may be used to measure parameters pertaining to a gas path in a turbine engine. The support 12 also supports wires or the like associated with the probes.

The cover (e.g., from stock plates) 13 is removably secured to the support 12. The cover 13 may be removed to provide access to an interior of the support 12, for instance for installation, repairs or maintenance.

The probes 14 measure parameters. The probes 14 may be thermocouples measuring the temperature along a gas path in turbine engine. The probes 14 may be pressure sensors/pressure transducers.

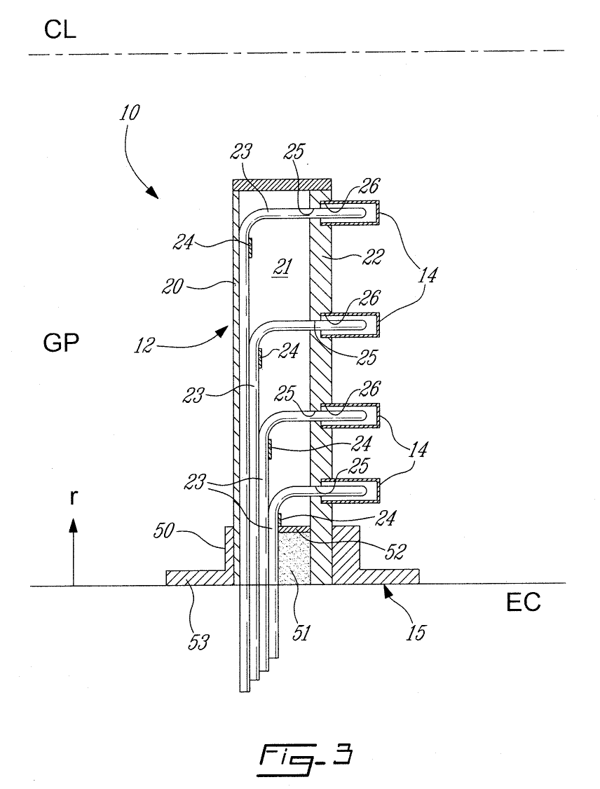

The holder 15 connects a base of the support 12 to a structure of the turbine engine, such that the support 12 extends radially into the gas path GP (FIG. 3). Although shown as being separate from the support 12 in FIGS. 1 to 4, the holder 15 may be integral with the support 12.

Referring concurrently to FIGS. 2 and 3, the support 12 has a casing 20. The casing 20 may be machined (e.g., from a solid piece) or cast in a suitable material. The casing 20 is mounted to a gas turbine engine casing EC, within an engine gas path GP having a central axis or centerline CL. A base of the casing 20 is mounted to the engine casing EC for instance via the holder 15, such that the casing 20 extends into the engine gas path in a radial direction r. The probes 14 are located a various radial positions along the gas path GP, to facilitate providing gas path measurements radially though at least a portion of the gas path. Among the walls and surfaces defining the casing 20, there is a wire surface 21, and a probe wall 22. The wire surface 21 is generally planar within the casing 20, with the wire units 23 lying thereon. The probe wall 22 extends radially into the gas path GP, and is oriented so as to support the probes 14 at different gas path radii. For simplicity purposes, reference is made to wire units 23 in the present description, but piping or the like may be used in accordance with the type of probe that is used. Moreover, wire units relate to a unit of wires required to operate a probe, and may thus be one or more wires.

The wire units 23 are held captive by shim clamps 24 (i.e., straps), so as to be retained or constrained from moving in the casing 20. The shim straps 24 are typically welded to the wire surface 21, so as to hold the wire units 23 in the arrangement of FIGS. 2 and 3, with each wire unit 23 having an elbow shape. Tweezer welding, micropoint welding, spot welding or similar welding techniques may be used to secure the shim straps 24 to the wire surface 21. The welding techniques are selected in view of the removal and replacement of the shim straps 24, for instance to change the wire units 23. Alternatives to the shim straps 24 may be used, such as straps, hooks or the like. The wire units 23 must be strapped or held captive in the support 12, whereby movement of the wire units 23 is constrained.

The probe wall 22 is generally perpendicular to the wire surface 21 and therefore extends radially into the gas past GP (FIG. 3), and has throughbores 25. Each throughbore 25 may have a counterbore 26 oriented outwardly. The shim straps 24 are positioned on the wire surface 21 so as to allow each of the wire units 23 to be oriented toward and through the throughbores 25. The throughbores 25 are sized so as to snugly accommodate the wire units 23, with the free ends of the wire units 23 protruding out of the casing 20 through the throughbores 25. The throughbores 25 are aligned in the casing 20.

The probes 14 are connected to the free ends of the wire units 23, and are each mated into one of the counterbores 26. The counterbores 26 are sized so as to matingly hold the probes 14 in such a way that the probes are in a non-integral relation with the casing 20. Therefore, no brazing or like fusion-based technique is used to connect the probes 14 to the support 12, and no mechanical fastener is provided on the outer periphery of the probes 14. For instance, an interference may be provided between the probe 14 and the periphery of the counterbore 26. Alternative geometries to a counterbore may be used, such as a counterbore.

Referring concurrently to FIGS. 1-3, an embodiment of the holder 15 is shown having a housing 50. The support 12 is mated into the housing 50, with the wire units 23 exiting through an outlet of the casing 20 and through the housing 50 so as to be connected to a processor (not shown). A potting or insulating compound 51 (e.g., ceramic potting) may be used at the junction of the support 12 and the housing 50, or within the casing 20 of the support 12 and about the wire units 23, to form an insulating barrier. Shims 52 may be used to contain the potting compound 51.

The holder 15 has a flange 53, by which the housing 50 is held in place on a structure. For instance, the flange 53 may be provided with throughbores 54, so as to be connected to a structure by mechanical fasteners. Other techniques for fixing the holder 15 to a structure may be used.

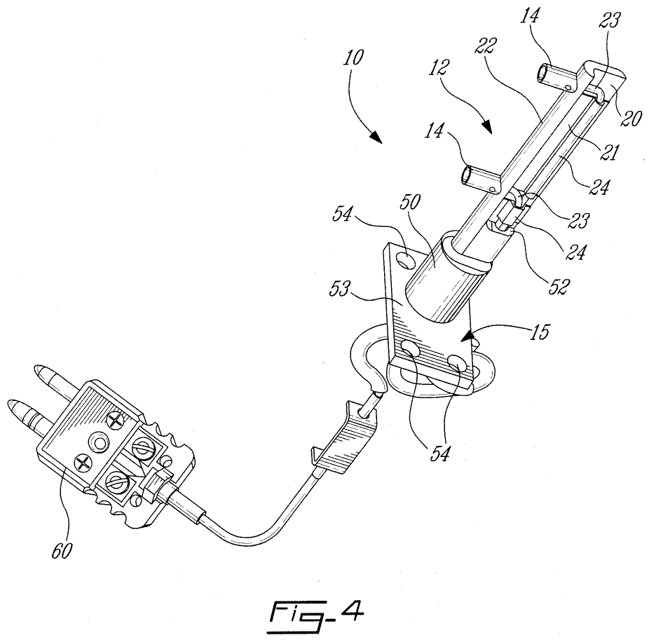

Referring to FIG. 4, the wire units 23 are shown having a plug 60 extending away from the support 12. Depending on the type of probes, the wire units 23 or like members (e.g. piping or tubing) may be equipped with other types of interfaces. Moreover, in FIG. 4, there is illustrated an alternative embodiment of a multipoint probe assembly, featuring two probes 14, with a cover removed to show an interior of the assembly. Multipoint probe assemblies may have two or more probes 14.

As they are not mechanically fixed to the support 12, the probes 14 are readily installed to or removed from the support 12. Moreover, the wire units 23, straps 24, the ceramic potting compound 51 are also readily installed to or removed from the support 12, by the way they are mounted to the support 12.

A method for installing the probe assembly 10 to an engine casing EC (FIG. 3), in such a way that the probe assembly 10 extends radially into the gas path GP, is now described.

Referring to FIGS. 1 to 3, the support casing 20 is secured at its base to the engine casing 20, in such a way that the support casing 20 extends radially into the gas path GP (FIG. 3). For instance, the holder 15 may be used to secure the casing 20 to the engine casing 20. Wire units 23 are inserted into the support casing 20. A first end of one wire unit 23 is threaded in one of the throughbore 25, while a second end of the wire unit 23 is passed through an outlet of the support casing 20. This is repeated for all throughbores 25. Probes 14 are then inserted into each throughbore 25 from an exterior of the casing 20 to connect the probe 14 to the end of the wire unit 23 in the throughbore 25. Accordingly, the probes 14 at different radii in the gas path GP (FIG. 3). The wire units 23 are then strapped to an interior of the casing 20 to constrain movement of the wire units 23. The wire units 23 may be shaped into elbows or in any other suitable shape. The outlet of the casing 20 may then be insulated with a compound. The above described method may be performed in any suitable order.

In order to replace one of the probes 14, the defective probe 14 is removed from the throughbore 25. A replacement probe is then inserted into the emptied throughbore 25 from an exterior of the casing 20 to connect the replacement probe to the first end of the wire unit 23 associated with the throughbore 25. The wire units 23 and straps 24 may also be replaced.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

What is claimed is:

1. A probe assembly for measuring one of temperature and pressure in a gas path of a gas turbine engine, the assembly comprising:
a support casing having a first wall with at least two throughbores in the first wall, the support casing having a base mounted to a gas turbine engine proximate the gas path, the first wall extending from the base and configured for extending radially into the gas path, the at least two throughbores provided at positions in the first wall corresponding to different gas path radii;
wire units within the support casing, each wire unit having a first end directed to an own one of the throughbores, and a second end exiting through an outlet of the casing and adapted to be connected to a processing unit;
retaining members secured to an inside of the casing and constraining movement of the wire units with respect to the support casing; and
probes for each of the throughbores configured for measuring at least one of temperature and pressure, the probes having a connector end received in a non-integral relation in the throughbore and connected to an associated one of the wire units;
whereby the probes in the non-integral relation with the support casing are actuated to measure parameters in the gas path of the gas turbine engine.

2. The probe assembly according to claim 1, wherein the retaining members are straps strapping the wire units to the support casing.

3. The probe assembly according to claim 2, wherein the straps are micropoint welded to the support casing.

4. The probe assembly according to claim 2, wherein the straps are positioned so as to hold the wire units in an elbow shape.

5. The probe assembly according to claim 1, wherein the throughbores each have a counterbore portion oriented toward an exterior of the support casing to receive the connector end of the probes.

6. The probe assembly according to claim 1, wherein the support casing has at least three throughbores in a linear relation in the support casing.

7. The probe assembly according to claim 1, further comprising a cover releasably welded to the support casing to provide an access to an interior of the support casing.

8. The probe assembly according to claim 1, further comprising an insulating compound in the outlet of the support casing.

9. The probe assembly according to claim 8, further comprising at least one shim to contain the insulating compound.

10. A method for installing probes in a gas path of a gas turbine engine, comprising:
providing a support casing having a first wall with at least two throughbores in a gas turbine engine, the first wall extending radially into the gas path;
positioning wire units within the support casing;
threading a first end of one said wire unit in each said throughbore and a second end of each said wire unit through an outlet of the support casing to a processing unit;
inserting a probe into each said throughbore from an exterior of the support casing to connect the probe to the first end of the wire unit;
strapping the wire units to an interior of the support casing to constrain movement of the wire units; and
closing the support casing for measuring with the probes parameters in the gas path.

11. The method according to claim 10, wherein strapping the wire units comprises welding shims to an interior of the casing.

12. The method according to claim 11, wherein welding shims to the interior of the casing comprises micropoint welding the shims to the interior of the casing.

13. The method according to claim 10, wherein strapping the wire units to the interior of the support casing comprises shaping the wire units into an elbow shape.

14. The method according to claim 10, further comprising insulating the outlet of the support casing with a compound.

15. The method according to claim 10, further comprising:
disconnecting one of the probe by removing the probe from the throughbore; and
inserting a replacement probe into said throughbore from an exterior of the support casing to connect the probe to the first end of the wire unit associated with the throughbore.
